(19) United States
(12) Patent Application Publication
(10) Pub. No.: US 2026/0359941 A1
(43) Pub. Date: Nov. 12, 2026

(54) TERMINAL IMAGE QUALITY ENHANCEMENT METHOD AND DEVICE, AND COMPUTER READABLE STORAGE MEDIUM

(71) Applicant: BOE Technology Group Co., Ltd., Beijing (CN)

(72) Inventors: Dan ZHU, Beijing (CN); Yan GAO, Beijing (CN); Ran DUAN, Beijing (CN)

(21) Appl. No.: 19/125,734

(22) PCT Filed: Oct. 8, 2023
(86) PCT No.: PCT/CN2023/123375

§ 371 Date: Apr. 29, 2025

(30) Foreign Application Priority Data
Nov. 17, 2022 (CN) 202211460861.9

(51) Int. Cl. G06T 5/60; G06T 3/4053

(52) U.S. Cl. CPC G06T 5/60; G06T 3/4053; G06T 2207/20081; G06T 2207/20092

(57) ABSTRACT

A terminal image quality enhancement method and device, and a computer readable storage medium. The terminal image quality enhancement method comprises: acquiring image quality enhancement parameters of a user; according to the image quality enhancement parameters of the user, determining the number of cycles J for performing image quality enhancement by using an image quality enhancement model; and receiving an image to be enhanced, and cyclically using the image quality enhancement model to perform image quality enhancement on said image for J times, wherein the input image of the image quality enhancement model during the first cycle is said image, the input image of the image quality enhancement model during the j-th cycle is the output image of the image quality enhancement model during the (j−1)-th cycle, internal parameters used by the image quality enhancement model in the J cycles are the same, and J≥j>1.

### CROSS-REFERENCE TO RELATED APPLICATIONS

The present application is a U.S. National Phase Entry of International Application PCT/CN2023/123375 having an international filing date of Oct. 8, 2023, which claims priority to Chinese Patent Application No. 202211460861.9 filed to the CNIPA on Nov. 17, 2022, and entitled “Terminal Image Quality Enhancement Method and Device, and Computer Readable Storage Medium”, contents of which should be understood as being incorporated herein by reference.

### TECHNICAL FIELD

Embodiments of the present disclosure relate to, but are not limited to, the technical field of image quality enhancement, and particularly relate to a terminal image quality enhancement method and apparatus, and a computer readable storage medium.

### BACKGROUND

Image quality refers to picture quality. In actual playing scenes, it is often necessary to improve image quality of terminals such as TVs. For example, when a 2K resolution TV is used to play standard definition video, or a 4K resolution TV is used to play standard definition or 2K resolution video, mismatch between a resolution of a video source and a screen display resolution leads to a problem of poor display effect, such as blurred pictures and jagged pictures. However, due to limited computing power and storage space of terminals such as TVs, current terminal image quality enhancement methods often cannot meet lightweight requirements of actual scenarios.

### SUMMARY

The following is a summary of subject matter described herein in detail. This summary is not intended to limit the protection scope of claims.

An embodiment of the present disclosure provides a terminal image quality enhancement method, including: acquiring an image quality enhancement parameter of a user; determining a number of cycles J of image quality enhancement using an image quality enhancement model according to the image quality enhancement parameter of the user; receiving an image to be enhanced, and cyclically using the image quality enhancement model to enhance image quality of the image to be enhanced for J times, wherein an input image of the image quality enhancement model in a first cycle is the image to be enhanced, an input image of the image quality enhancement model in a j-th cycle is an output image of the image quality enhancement model in a (j−1)-th cycle, and internal parameters of the image quality enhancement model used in a process of J cycles are the same, J≥j>1.

An embodiment of the present disclosure also provides a terminal image quality enhancement apparatus, including a memory; and a processor connected to the memory, wherein the memory is configured to store instructions, and the processor is configured to perform steps of the terminal image quality enhancement method according to any embodiment of the present disclosure based on the instructions stored in the memory.

An embodiment of the present disclosure also provides a computer readable storage medium storing a computer program thereon, and when the program is executed by a processor, the terminal image quality enhancement method according to any embodiment of the present disclosure is implemented.

Other aspects may be comprehended upon reading and understanding drawings and detailed description.

### BRIEF DESCRIPTION OF DRAWINGS

Accompanying drawings are used for providing further understanding of technical solutions of the present disclosure, constitute a portion of the specification, and are used for explaining the technical solutions of the present disclosure together with embodiments of the present disclosure, but do not constitute limitations on the technical solutions of the present disclosure. Shapes and sizes of various components in the drawings do not reflect actual scales, but are only intended to schematically illustrate contents of the present disclosure.

FIG. 1 is a schematic flow diagram of a terminal image quality enhancement method according to an exemplary embodiment of the present disclosure.

FIG. 2 is a schematic diagram of an image quality enhancement scheme using an image Super-Resolution (SR) model according to an exemplary embodiment of the present disclosure.

FIG. 3 is a schematic diagram of a structure of an image super-resolution model according to an exemplary embodiment of the present disclosure.

FIG. 4 is a schematic diagram of an image quality enhancement scheme using a clarity enhancement (BP) model according to an exemplary embodiment of the present disclosure.

FIG. 5 is a schematic diagram of a structure of a clarity enhancement model according to an exemplary embodiment of the present disclosure.

FIG. 6 is a schematic diagram of a training method of an image super-resolution model according to an exemplary embodiment of the present disclosure.

FIG. 7 is a schematic diagram of a process of first performing Float32 precision training and then using Int8 quantization training according to an exemplary embodiment of the present disclosure.

FIG. 8 is a schematic diagram of a training method of a clarity enhancement model according to an exemplary embodiment of the present disclosure.

FIG. 9 is a schematic diagram of an image quality enhancement module for a television terminal according to an exemplary embodiment of the present disclosure.

FIG. 10 is a schematic diagram of a front-end parameter setting method of a terminal image quality enhancement module according to an exemplary embodiment of the present disclosure.

FIG. 11 is a schematic diagram of a structure of a terminal image quality enhancement apparatus according to an exemplary embodiment of the present disclosure.

### DETAILED DESCRIPTION

To make objectives, technical solutions, and advantages of the present disclosure clearer, the embodiments of the present disclosure will be described in detail below with reference to the accompanying drawings. It is to be noted that the embodiments and features in the embodiments of the present disclosure may be randomly combined with each other if there is no conflict.

Unless otherwise defined, technical terms or scientific terms used in the embodiments of the present disclosure should have usual meanings understood by those of ordinary skills in the art to which the present disclosure belongs. “First”, “second”, and similar terms used in the embodiments of the present disclosure do not represent any order, quantity, or importance, but are only used for distinguishing different components. “Include”, “contain”, or a similar word means that an element or object appearing before the word covers an element or article and equivalent thereof listed after the word, and other elements or objects are not excluded.

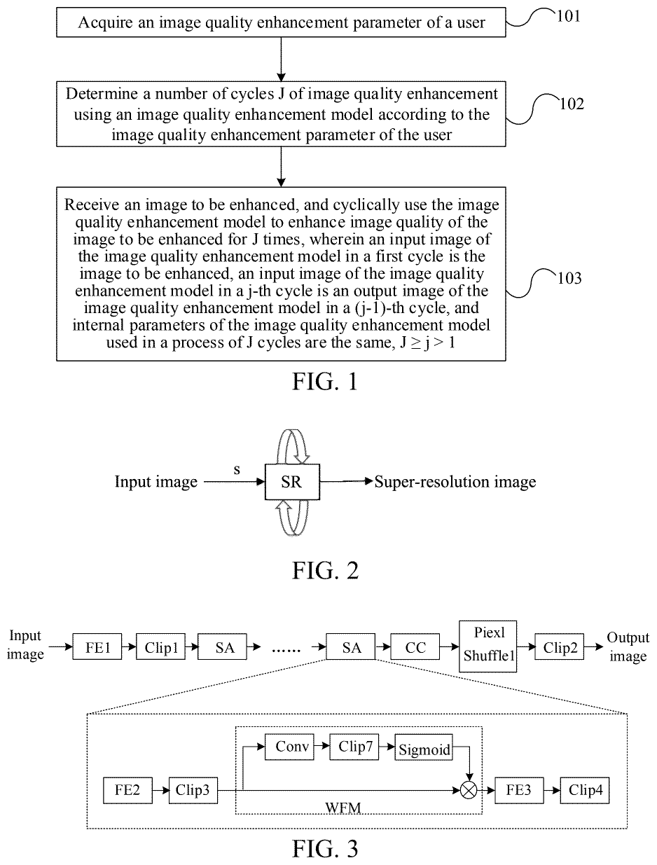

As shown in FIG. 1, an embodiment of the present disclosure provides a terminal image quality enhancement method, which includes following steps.

Step 101: acquiring an image quality enhancement parameter of a user.

Step 102: determining a number of cycles J of image quality enhancement using an image quality enhancement model according to the image quality enhancement parameter of the user.

Step 103: receiving an image to be enhanced, and cyclically using the image quality enhancement model to enhance image quality of the image to be enhanced for J times, wherein an input image of the image quality enhancement model in a first cycle is the image to be enhanced, an input image of the image quality enhancement model in a j-th cycle is an output image of the image quality enhancement model in a (j−1)-th cycle, and internal parameters of the image quality enhancement model used in a process of J cycles are the same, J≥j>1.

In the terminal image quality enhancement method according to the embodiment of the present disclosure, the number of cycles J of image quality enhancement is determined using the image quality enhancement model according to the image quality enhancement parameter of the user, and then the image quality enhancement model is cyclically used to enhance the image quality of the image to be enhanced for J times, and the internal parameters of the image quality enhancement model used in the process of J cycles (an internal parameter of the image quality enhancement model here refers to an optimal parameter obtained through training samples in model training) are the same, and memory occupied by the model is merely memory occupied by a single model, which can greatly reduce memory consumption of hardware, make the model lightweight and meet low computing power requirements of a terminal.

In some exemplary implementation modes, as shown in FIG. 2, the image quality enhancement model may be an image Super-Resolution (SR) model, and the image quality enhancement parameter is a first image quality enhancement parameter s, wherein J=s, x=2^{s}, x is a resolution enhancement magnification between an output image of the image super-resolution model and the image to be enhanced in a J-th cycle. In the embodiment of the present disclosure, the first image quality enhancement parameter s may be understood as a number of 2-fold super-resolution cycles, and for example, no super-resolution (s=0), 2-fold super-resolution (s=1), 4-fold super-resolution (s=2), 8-fold super-resolution (s=3), 16-fold super-resolution (s=4), 32-fold super-resolution (s=5), and the like may be selected. SR in FIG. 2 may be regarded as a 2-fold super-resolution module, and internal parameters of the image super-resolution model used in multiple cycles (an internal parameter of the image super-resolution model here refers to an optimal parameter obtained through training samples in model training) are the same.

In some exemplary implementation modes, as shown in FIG. 3, the image super-resolution model includes a first feature extraction layer FE1, a first clip layer Clip1, m serially connected spatial attention layers SA, a channel adjustment layer CC, a first upsampling layer Pixel Shuffle1, and a second clip layer Clip2 connected in sequence, m being a natural number between 2 and 5. Here, the first feature extraction layer FEL is configured to extract a feature map of an input image of the image super-resolution model; the first clip layer Clip1 is configured to limit a numerical value of a feature map output by the first feature extraction layer FE1 within a preset range; the m serially connected spatial attention layers SA are configured to perform feature screening and enhancement on the feature map output by the first clip layer Clip1; the channel adjustment layer CC is configured to adjust a number of channels of the feature map; the first upsampling layer Pixel Shuffle1 is configured to convert the feature map output by the channel adjustment layer CC into a high-resolution image; the second clip layer Clip2 is configured to limit a numerical value of the high-resolution image output by the first upsampling layer Pixel Shuffle1 within a preset range.

In actual use, m may be set according to hardware conditions of the terminal, for example, m may be set to 2 or 3.

In some exemplary implementation modes, as shown in FIG. 3, each spatial attention layer SA includes a second feature extraction layer FE2, a third clip layer Clip3, a weighted feature mapping layer WFM, a third feature extraction layer FE3, and a fourth clip layer Clip4. Here, the second feature extraction layer FE2 is configured to perform feature refinement on a feature map input to the current spatial attention layer SA; the third clip layer Clip3 is configured to limit a numerical value of a feature map output by the second feature extraction layer FE2 within a preset range; the weighted feature mapping layer WFM is configured to calculate a spatial attention weight, and multiply the calculated spatial attention weight with a feature map output by the third clip layer Clip3 to obtain a weighted feature map; the third feature extraction layer FE3 is configured to perform feature refinement on the weighted feature map; the fourth clip layer Clip4 is configured to limit a numerical value of a feature map output by the third feature extraction layer FE3 within a preset range.

In some exemplary implementation modes, as shown in FIG. 3, the weighted feature mapping layer WFM may include a first branch, a second branch, and a multiplier. The first branch and the second branch are both disposed between the third clip layer Clip3 and the multiplier, and the first branch includes a first convolution layer Conv, a seventh clip layer Clip7, and an activation function layer Sigmoid that are sequentially connected in series.

In some exemplary implementation modes, the first convolution layer Conv may be a convolution layer having a convolution kernel size of 1*1 or 3*3, however, embodiments of the present disclosure are not limited thereto. For the first convolution layer Conv, a convolution layer with a convolution kernel size of 1*1 is adopted, which may further reduce the computing power requirements of the terminal.

In some exemplary implementation modes, the first feature extraction layer FE1 may be a convolution layer having a convolution kernel size of 3*3, however, embodiments of the present disclosure are not limited thereto.

In some exemplary implementation modes, the second feature extraction layer FE2 may be a convolution layer having a convolution kernel size of 3*3, however, embodiments of the present disclosure are not limited thereto.

In some exemplary implementation modes, the third feature extraction layer FE3 may be a convolution layer having a convolution kernel size of 1*1 or 3*3, however, embodiments of the present disclosure are not limited thereto. For the third feature extraction layer FE3, a convolution layer with a convolution kernel size of 1*1 is adopted, which may further reduce the computing power requirements of the terminal.

In some exemplary implementation modes, the channel adjustment layer CC may be a convolution layer having a convolution kernel size of 1*1, however, embodiments of the present disclosure are not limited thereto.

In some exemplary implementation modes, a clip layer Clip (which may be any one of the first clip layer Clip1, the second clip layer Clip2, the third clip layer Clip3, the fourth clip layer Clip4, and the seventh clip layer Clip7, or any one of a fifth clip layer Clip5 and a sixth clip layer Clip6 described later) serves a role of clipping, and a clipping value may be between 0 and 1 (when a model output value is a normalized value) or between 0 and 255 (when the model output value is not normalized), which is expressed by a following formula.

$$clip ( x ) = \{ \begin{matrix}0 , & x \leq 0 \\ 1 , & x \geq 1\end{matrix} ; or ; clip ( x ) = \{ \begin{matrix}0 , & x \leq 0 \\ 255 , & x \geq 255\end{matrix} .$$

A function of the clip layer Clip is to ensure that an output value of a convolution function of each layer is between 0-1 (or 0-255), which is conducive to subsequent model quantization training and reduces a quantization loss. In the image super-resolution model of the embodiment of the present disclosure, the clip layer Clip is adopted subsequent to each convolution layer, which is beneficial to maintain accuracy performance of the model to the greatest extent during Int8 quantization training.

In some exemplary implementation modes, the image quality enhancement model may be a clarity enhancement model, and the image quality enhancement parameter is a second image quality enhancement parameter w, wherein 0<w≤100%.

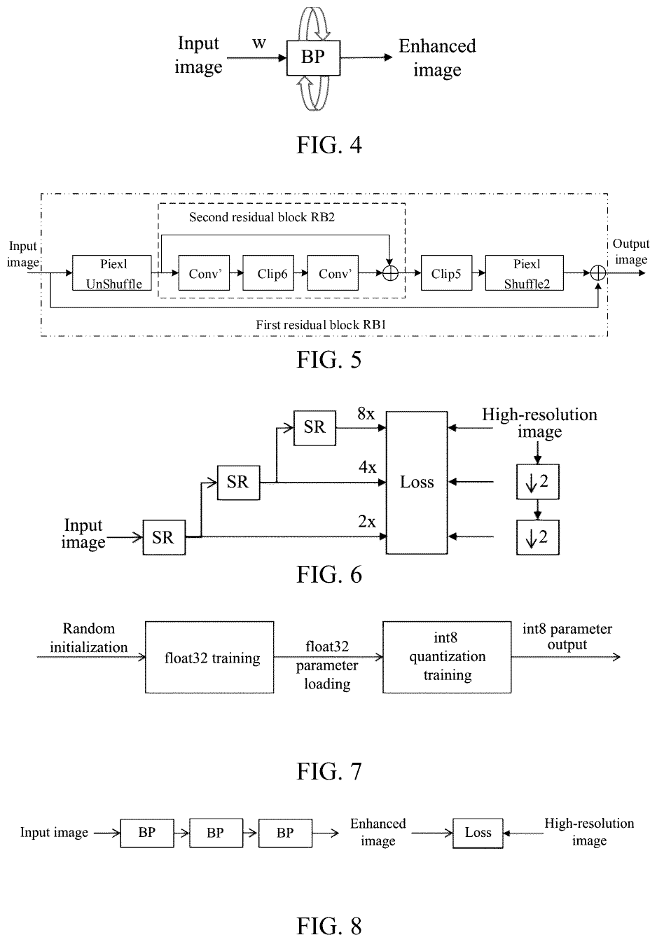

As shown in FIG. 4, BP may be regarded as a primary clarity enhancement module, and internal parameters of a clarity enhancement model used in multiple cycles (an internal parameter of the clarity enhancement model here refers to an optimal parameter obtained through training samples in model training) are the same. In the embodiment of the present disclosure, the clarity enhancement model is of a BackProjection structure, which includes one downsample layer (PixelUnShuffle or other) and one upsample layer (PixelShuffle or other). An input of the BP structure is an image, and an output of the BP structure is also an image, its structure is a residual structure, that is, substantial content obtained by the clarity enhancement module is a residual of an enhancement map and an input map, that is, an enhanced detail part. The second image quality enhancement parameter w is an intensity coefficient of adjusting an enhancement effect by a current user, and a value of w is between 0 and 100%.

In some exemplary implementation modes, determining the number of cycles J of image quality enhancement using the image quality enhancement model according to the image quality enhancement parameter of the user includes: determining a maximum number of cycles I, and dividing 0 to 100% into I equal parts, with i-th equal part corresponding to a percentage of enhancement of A*100%, (i−1)/I<A≤i/I, and i is a natural number between 1 and I; determining a number of equal parts corresponding to the second image quality enhancement parameter w is the number of cycles J of image quality enhancement using the clarity enhancement model.

When the clarity enhancement model according to the embodiment of the present disclosure is actually used to perform image quality enhancement, the user may control an enhancement effect by adjusting the second image quality enhancement parameter w. For example, assuming that the maximum number of cycles I=5, an enhancement degree may be divided into following five levels (a number of levels is the maximum number of cycles).
0%--20%--40%--60%--80%--100%.

When the user adjusts a slider bar of the enhancement effect, if the second image quality enhancement parameter w is 0%, no enhancement is performed, that is, the clarity enhancement model is not used for image quality enhancement; when a size of the second image quality enhancement parameter w is between (0%, 20%], the clarity enhancement model is used for image quality enhancement once: Pout=BP¹(P)=BP(P); when the size of the second image quality enhancement parameter w is between (20%, 40%], the clarity enhancement model is cyclically used to perform image quality enhancement twice: Pout=BP²(P)=BP(BP¹(P)); when the size of the second image quality enhancement parameter w is between (40%, 60%], the clarity enhancement model is used cyclically for image quality enhancement 3 times (which may be set as a default configuration): Pout=BP³(P)=BP(BP²(P)); when the size of the second image quality enhancement parameter w is between (60%, 80%], the clarity enhancement model is cyclically used for image quality enhancement 4 times: Pout=BP⁴(P)=BP(BP³(P)); when the size of the second image quality enhancement parameter w is between (80%, 100%], the clarity enhancement model is cyclically used for image quality enhancement 5 times: Pout=BP⁵(P)=BP(BP⁴(P)).

In some exemplary implementation modes, when the second image quality enhancement parameter w is not equal to an integer multiple of 1/I, the terminal image quality enhancement method further includes: calculating a difference coefficient w′ according to a following formula, w′=w*I−J+1; and determining that an output image is BP^{J-1}(P)+w′*(BP^{J}(P)−BP^{J-1}(P)), wherein BP^{J-1}(P) is an output image of the clarity enhancement model in a (J−1)-th cycle, BP^{J}(P) is an output image of the clarity enhancement model in a J-th cycle.

In the embodiment of the present disclosure, in order to enable the user to obtain a continuous clarity change process between each of the levels, when the second image quality enhancement parameter w falls into one of the above levels, for example, assuming that the second image quality enhancement parameter w adjusted by the user=35%, which falls into the (20%, 40%] level, the clarity enhancement model is cyclically used to perform image quality enhancement twice, and then 35% is linearly mapped by 0-1 in the range of (20%, 40%] w′=(35%-20%)/(40%-20%)=0.75 (i.e.,w=w*I−J+1=35%*5−2+1=0.75), then an enhanced image at this time is Pout=BP¹(P)+0.75*(BP²(P)−BP¹(P)).

For another example, assuming that the image quality enhancement parameter w=65% adjusted by the user falls into the (60%, 80%] level at this time. At this time, the clarity enhancement model is cyclically used to enhance image quality 4 times. According to the above calculation, it may be obtained: w′=(65%-60%)/(80%-60%)=0.25 (i.e., w′=w*I−J+1=65%*5−4+1=0.25), then an enhanced image at this time is Pout=BP³(P)+0.25*(BP⁴(P)−BP³(P)).

In this way, the user may get a continuous enhancement effect through the slider bar. When in use, it may be that the default configuration is 3 cycles, and a program supports setting 4 or 5 cycles, which may ensure that when an original video picture that needs to be enhanced is particularly blurred, more times of clarity enhancement are needed to achieve a more ideal effect, thus providing users with an enhancement effect of a wider space.

In some exemplary implementation modes, determining the maximum number of cycles I includes: detecting computing power space M that the current terminal can provide to an image quality enhancement algorithm; determining whether M is greater than or equal to I2*M_{bp}, wherein I2 is a maximum number of cycles that the terminal supports cyclically using the clarity enhancement model in an ideal situation, M_{bp} is the computing power space required for performing image quality enhancement on the image to be enhanced once by using the clarity enhancement model; when M is greater than or equal to I2*M_{bp}, setting the maximum number of cycles I=I2; when M is less than I2*M_{bp}, setting the maximum number of cycles I=└M/M_{bp}┘, wherein └M/M_{bp}┘ means rounding down M/M_{bp}.

In an ideal situation, it is believed that computing power of a device such as a TV or a mobile terminal can stably and reliably support cyclically using the clarity enhancement model for image quality enhancement for I2 (exemplary, I2=5) times. However, when the TV starts many other modules at the same time or the mobile terminal runs many other application programs in the background at the same time, a situation that occasionally, computing power occupation cannot provide sufficient computing power for the clarity enhancement model. At this time, the terminal image quality enhancement method according to the embodiment of the present disclosure may achieve online real-time adjustment of a number of times of image quality enhancement using the clarity enhancement model to complete enhancement processing, as follows:
assuming that computing power required for image quality enhancement once by using the clarity enhancement model is M_{bp}, computing power space that a terminal device can provide to an image quality enhancement algorithm is M after online detection, when M≥I₂*M_{bp}, setting a maximum number of cycles I=I2, and then determining a number of cycles to perform enhancement according to the above logic. When M<I2*M_{bp}, recalculating the maximum number of cycles that can be run I=└M/M_{bp}┘, wherein └M/M_{bp}┘ means rounding down M/M_{bp} (regardless of a situation that one cycle cannot be run). According to the maximum number of cycles obtained by recalculation, 0-100% is divided into I equal parts, and then the number of cycles is determined according to the aforementioned logic for enhancement. By resetting the maximum number of cycles I according to this method, a number of times of cyclic enhancement of the image to be enhanced using the clarity enhancement model can be adaptively controlled online and real-time according to hardware performance.

For example, when I=5, an enhancement degree may be divided into following five levels.
0%--20%--40%--60%--80%--100%.

When I=4, the enhancement degree may be divided into following four levels.
0%--25%--50%--75%--100%.

When I=3, the enhancement degree may be divided into following three levels.
0%--33%--66%--100%.

When I=2, the enhancement degree may be divided into following two levels.
0%--50%--100%.

When I=1, the enhancement degree may be divided into following one level.

When there is one BP, a region is divided into: 0%-100%.

The clarity enhancement model of the embodiment of the present disclosure is of a BackProjection structure, which is a residual structure as shown in FIG. 5, and includes one downsampling layer (Pixel UnShuffle or other) and one upsampling layer (Pixel Shuffle or other).

In some exemplary implementation modes, as shown in FIG. 5, the clarity enhancement model includes a first residual block RB1 including a first main branch, a first shortcut branch, and a first adder. The first main branch and the first shortcut branch are both disposed between an input image and the first adder, and the first residual block RB1 is configured to sum the input image and the input image after being processed by the first main branch and output it; the first main branch includes a downsampling layer Pixel UnShuffle, a second residual block RB2, a fifth clip layer Clip5, and a second upsampling layer Pixel Shuffle2 connected in sequence, wherein the downsampling layer Pixel UnShuffle is configured to downsample the input image to obtain a downsampled image; the second residual block RB2 includes a second main branch, a second shortcut branch, and a second adder, wherein both the second main branch and the second shortcut branch are disposed between the downsampling layer Pixel UnShuffle and the second adder, the second main branch includes a plurality of second convolution layers Conv′ and a sixth clip layer Clip6 disposed between the plurality of second convolution layers Conv′; the fifth clip layer Clip5 is configured to limit a numerical value of a feature map output by the second residual block RB2 within a preset range; the second upsampling layer Pixel Shuffle2 is configured to convert a feature map output by the fifth clip layer Clip5 into a high-resolution image.

In some exemplary implementation modes, a second convolution layer Conv′ may be a convolution layer having a convolution kernel size of 3*3, however, embodiments of the present disclosure are not limited thereto.

In some exemplary implementation modes, a quantity of second convolution layers Conv′ in the second main branch may be between 1 and 3. For example, a quantity of second convolution layers Conv′ in the second main branch may be two.

In the embodiment of the present disclosure, a function of a clip layer Clip (any one of the fifth clip layer Clip5 and the sixth clip layer Clip6) is to ensure that an output numerical value of a convolution function of each layer is between 0-1 (or 0-255), which is beneficial to subsequent model quantization training and reduces a quantization loss. In the clarity enhancement model of the embodiment of the present disclosure, the clip layer Clip is adopted subsequent to each convolution layer, which is beneficial to maintain accuracy performance of the model to the greatest extent during Int8 quantization training.

In some exemplary implementation modes, a training process of the image quality enhancement model includes: C series-connected image quality enhancement models with a same structure and a same internal parameter are used for training, and a loss of using 1 to C image quality enhancement models is calculated at the same time, and floating-point precision is adopted during the training; a trained floating-point image quality enhancement model is quantified into an integer image quality enhancement model.

In some exemplary implementation modes, a training process of the image super-resolution model includes: y series-connected image super-resolution models with a same structure and a same internal parameter are used for training, 1<y≤I1, where I1 is a maximum number of cycles that the terminal supports to use the image super-resolution model cyclically, and a loss of using 1 to y image super-resolution models at the same time is calculated, and floating-point precision is adopted during the training; a trained floating-point image super-resolution model is quantified into an integer image super-resolution model.

In an embodiment of the present disclosure, training an image super-resolution model includes two steps.
1) Floating-point training: as shown in FIG. 6, when floating-point training is performed on the image super-resolution model, internal parameters of multiple image super-resolution models are shared (assuming y=3, that is, the above three image super-resolution models have a same set of internal parameters of a same model, the image super-resolution model is cycled three times), and 2×/4×/8× super-resolution is trained at the same time and a loss of 2×/4×/8× is calculated at the same time, a loss function may be an absolute loss function (L1 Loss) or a Mean Square Error (MSE) loss function During the training, the model may be trained with Float32 precision.
2) As shown in FIG. 7, after completing the floating-point training, a Float32 precision model is loaded for Quantize-Aware Training (QAT), which can maintain quality accuracy of the model while greatly reducing inference costs. A training model in this step may be trained with Int8 precision.

In some exemplary implementation modes, a training process of the clarity enhancement model includes: z series-connected clarity enhancement models with a same structure and a same internal parameter are used for training, 1<z≤I2, I2 is a maximum number of cycles that the terminal supports to use the clarity enhancement model cyclically, and a loss of using 1 to z clarity enhancement models is calculated at the same time, and floating-point precision is adopted during training; a trained clarity enhancement model is quantified into an integer clarity enhancement model.

In an embodiment of the present disclosure, training the clarity enhancement model includes two steps.
1) Floating-point training: as shown in FIG. 8, when floating-point training is performed on the clarity enhancement model, internal parameters of multiple clarity enhancement models are shared (assuming z=3, that is, the above three clarity enhancement models have a same set of internal parameters of a same model, and the clarity enhancement model is cycled three times), and enhancement for once/twice/three times is trained at the same time and a loss of enhancement for once/twice/three times is calculated at the same time. For a loss function, an absolute loss function or mean square error loss function may be used. During the training, the model may be trained with Float32 precision.
2) As shown in FIG. 7, after completing the floating-point training, a Float32 precision model is loaded for Quantize-Aware Training, which can maintain quality accuracy of the model on a basis of greatly reducing inference costs. A training model in this step may be trained with Int8 precision.

In some exemplary implementation modes, the image quality enhancement model includes an image super-resolution model and a clarity enhancement model, and the image quality enhancement parameter includes a first image quality enhancement parameter s and a second image quality enhancement parameter w.

Determining the number of cycles J of image quality enhancement using the image quality enhancement model according to the image quality enhancement parameter of the user, includes: determining a number of cycles J1=s of image quality enhancement using the image super-resolution model; determining a maximum number of cycles I of image quality enhancement using the clarity enhancement model, and dividing 0 to 100% into I equal parts, and a percentage of enhancement corresponding to an i-th equal part is A*100%, wherein (i−1)/I<A≤i/I, and i is a natural number between 1 and I; and determining a number of equal parts corresponding to the second image quality enhancement parameter w as a number of cycles J2 of image quality enhancement using the clarity enhancement model.

Cyclically using the image quality enhancement model to enhance the image quality of the image to be enhanced for J times, includes: first cyclically using the clarity enhancement model to enhance the image quality of the image to be enhanced for J2 times, and outputting a first image quality enhanced picture; cyclically using the image super-resolution model to enhance image quality of the first image quality enhanced picture for J1 times, and outputting a second image quality enhanced picture.

Structures, using methods, and training methods of the image super-resolution model and the clarity enhancement model may be referred to the foregoing, and the embodiments of the present disclosure will not be repeated here.

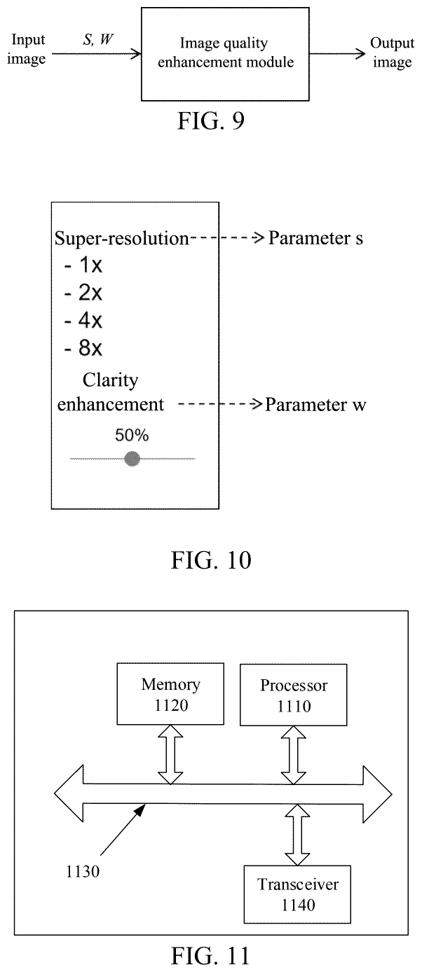

The terminal image quality enhancement method according to the embodiment of the present disclosure may be applied to a terminal such as a television/all-in-one machine/mobile terminal. Taking a television terminal as an example, as shown in FIG. 9, an image quality enhancement module is disposed in the television terminal, and the image quality enhancement module is divided into two parts: a super-resolution (i.e., image super-resolution) module and a clarity enhancement module: the above modules are started after the image quality enhancement module is turned on.

As shown in FIG. 10, for a super-resolution module, through the first image quality enhancement parameter s, it may be achieved that 1× (s=0), 2× (s=1), 4× (s=2), and 8× (s=3) magnifications are selected for resolution enhancement, wherein 1× means that no super-resolution operation is performed.

For the clarity enhancement module, a slider bar mode is set, and the second image quality enhancement parameter w is set between [0, 100%]. A specific rule may be referred to a setting logic of the number of cycles of the clarity enhancement model described above.

When setting is completed, the first image quality enhancement parameter s is transmitted to the super-resolution module, and the second image quality enhancement parameter w is transmitted to the clarity enhancement module, so that an image after image quality enhancement may be obtained.

An embodiment of the present disclosure further provides a terminal image quality enhancement apparatus, including a memory and a processor connected to the memory, wherein the memory is configured to store instructions, and the processor is configured to execute steps of the terminal image quality enhancement method according to any embodiment of the present disclosure based on the instructions stored in the memory.

As shown in FIG. 11, in an example, a terminal image quality enhancement apparatus may include a processor 1110, a memory 1120, a bus system 1130, and a transceiver 1140. The processor 1110, the memory 1120, and the transceiver 1140 are connected via the bus system 1130, the memory 1120 is configured to store instructions and an image quality enhancement model, and the processor 1110 is configured to execute the instructions stored in the memory 1120 to control the transceiver 1140 to transmit and receive signals. Specifically, the transceiver 1140 may acquire an image quality enhancement parameter of a user and receive an image to be enhanced under control of the processor 1110, and the processor 1110 determines a number of cycles J of image quality enhancement using the image quality enhancement model according to the image quality enhancement parameter of the user and cyclically uses the image quality enhancement model to enhance image quality of the image to be enhanced for J times, wherein an input image of the image quality enhancement model in a first cycle is the image to be enhanced, an input image of the image quality enhancement model in a j-th cycle is an output image of the image quality enhancement model in a (j−1)-th cycle, internal parameters of the image quality enhancement model used in J cycles are the same, J≥j>1, and an obtained output image is output to a display interface of a terminal through the transceiver 1140.

It should be understood that the processor 1110 may be a Central Processing Unit (CPU), or the processor 1110 may be another general-purpose processor, a Digital Signal Processor (DSP), an Application Specific Integrated Circuit (ASIC), a Field Programmable Gate Array (FPGA) or another programmable logic device, a discrete gate or a transistor logic device, a discrete hardware component, etc. The general-purpose processor may be a microprocessor, or the processor may be any conventional processor, etc.

The memory 1120 may include a read only memory and a random access memory, and provides instructions and data to the processor 1110. A portion of the memory 1120 may further include a non-volatile random access memory. For example, the memory 1120 may further store information of device types.

The bus system 1130 may further include a power bus, a control bus, a status signal bus, or the like in addition to a data bus. However, for the sake of clarity, various buses are all labeled as the bus system 1130 in FIG. 11.

In an implementation process, processing performed by a processing device may be completed through an integrated logic circuit of hardware in the processor 1110 or instructions in a form of software. That is, steps of the methods in the embodiments of the present disclosure may be embodied as executed by a hardware processor, or executed by a combination of hardware in the processor and a software module. The software module may be located in a storage medium such as a random access memory, a flash memory, a read only memory, a programmable read only memory or an electrically erasable programmable memory, a register. The storage medium is located in the memory 1120, and the processor 1110 reads information in the memory 1120 and completes the steps of the foregoing methods in combination with its hardware. In order to avoid repetition, detailed description is not provided here.

An embodiment of the present disclosure further provides a computer readable storage medium storing a computer program thereon, wherein when the program is executed by a processor, the terminal image quality enhancement method according to any embodiment of the present disclosure is implemented. A terminal image quality enhancement method implemented by executing the executable instructions is basically the same as the terminal image quality enhancement method provided in the above embodiment of the present disclosure, and will not be repeated here.

In some possible implementation modes, aspects of the terminal image quality enhancement method provided by the present application may also be implemented in a form of a program product, which includes a program code. When the program product is run on a computer device, the program code is used to enable the computer device to perform steps in the terminal image quality enhancement method according to various exemplary implementation modes of the present application as described in the specification. For example, the computer device may perform the terminal image quality enhancement method described in the embodiment of the present application.

For the program product, any combination of one or more readable media may be used. A readable medium may be a readable signal medium or a readable storage medium. The readable storage medium may be, for example, but is not limited to, an electrical, magnetic, optical, electromagnetic, infrared, or semiconductor system, apparatus, or device, or a combination of any of the above. More specific examples (non-exhaustive list) of the readable storage medium include: an electrical connection with one or more wires, a portable disk, a hard disk, a Random Access Memory (RAM), a Read Only Memory (ROM), an Erasable Programmable Read Only Memory (EPROM or flash memory), an optical fiber, a portable Compact Disk Read Only Memory (CD-ROM), an optical storage device, a magnetic storage device, or any suitable combination of the above.

Those of ordinary skills in the art may understand that all or some of steps in the methods disclosed above, systems, functional modules or units in apparatuses may be implemented as software, firmware, hardware, and an appropriate combination thereof. In a hardware implementation mode, division of the function modules/units mentioned in the above description is not always corresponding to division of physical components. For example, a physical component may have multiple functions, or a function or a step may be executed by several physical components in cooperation. Some components or all components may be implemented as software executed by a processor such as a digital signal processor or a microprocessor, or implemented as hardware, or implemented as an integrated circuit such as an application specific integrated circuit. Such software may be distributed on a computer readable medium, and the computer readable medium may include a computer storage medium (or a non-transitory medium) and a communication medium (or a transitory medium). As known to those of ordinary skills in the art, a term computer storage medium includes volatile and nonvolatile, and removable and irremovable media implemented in any method or technology for storing information (for example, a computer readable instruction, a data structure, a program module, or other data). The computer storage medium includes, but is not limited to, a RAM, a ROM, an Electrically Erasable Programmable Read Only Memory (EEPROM), a flash memory or another memory technology, a Compact Disc Read Only Memory (CD-ROM), a Digital Versatile Disk (DVD) or another optical disk storage, a magnetic cartridge, a magnetic tape, magnetic disk storage or another magnetic storage apparatus, or any other medium that may be configured to store desired information and may be accessed by a computer. In addition, it is known to those of ordinary skill in the art that the communication medium usually includes a computer readable instruction, a data structure, a program module, or other data in a modulated data signal of, such as, a carrier wave or another transmission mechanism, and may include any information delivery medium.

Although implementation modes disclosed in the present disclosure are described as above, the described contents are only implementation modes which are used for facilitating understanding of the present disclosure, but are not intended to limit the present invention. Any skilled person in the art to which the present disclosure pertains may make any modification and variation in a form and details of implementation without departing from the essence and scope of the present disclosure. However, the patent protection scope of the present invention should be subject to the scope defined in the appended claims.

1. A terminal image quality enhancement method, comprising:
acquiring an image quality enhancement parameter of a user;
determining a number of cycles J of image quality enhancement using an image quality enhancement model according to the image quality enhancement parameter of the user;
receiving an image to be enhanced, and cyclically using the image quality enhancement model to enhance image quality of the image to be enhanced for J times, wherein an input image of the image quality enhancement model in a first cycle is the image to be enhanced, an input image of the image quality enhancement model in a j-th cycle is an output image of the image quality enhancement model in a (j−1)-th cycle, and internal parameters of the image quality enhancement model used in a process of J cycles are the same, J≥j>1.

2. The terminal image quality enhancement method according to claim 1, wherein the image quality enhancement model is an image super-resolution model, and the image quality enhancement parameter is a first image quality enhancement parameter s, wherein J=s, x=2^{s}, x is a resolution enhancement magnification between an output image of the image super-resolution model in a J-th cycle and the image to be enhanced.

3. The terminal image quality enhancement method according to claim 2, wherein the image super-resolution model comprises a first feature extraction layer, a first clip layer, m series-connected spatial attention layers, a channel adjustment layer, a first upsampling layer, and a second clip layer connected in sequence, with m being a natural number between 2 and 5, wherein:
the first feature extraction layer is configured to extract a feature map of an input image of the image super-resolution model;
the first clip layer is configured to limit a numerical value of a feature map output by the first feature extraction layer within a preset range;
the m series-connected spatial attention layers are configured to perform feature screening and enhancement on a feature map output by the first clip layer;
the channel adjustment layer is configured to adjust a number of channels of the feature map;
the first upsampling layer is configured to convert a feature map output by the channel adjustment layer into a high-resolution image; and
the second clip layer is configured to limit a numerical value of the high-resolution image output by the first upsampling layer within a preset range.

4. The terminal image quality enhancement method according to claim 3, wherein each of the spatial attention layers comprises a second feature extraction layer, a third clip layer, a weighted feature mapping layer, a third feature extraction layer, and a fourth clip layer, wherein:
the second feature extraction layer is configured to perform feature refinement on a feature map input by a current spatial attention layer;
the third clip layer is configured to limit a numerical value of a feature map output by the second feature extraction layer within a preset range;
the weighted feature mapping layer is configured to calculate a spatial attention weight, and multiply the calculated spatial attention weight with a feature map output by the third clip layer to obtain a weighted feature map;
the third feature extraction layer is configured to perform feature refinement on the weighted feature map; and
the fourth clip layer is configured to limit a numerical value of a feature map output by the third feature extraction layer within a preset range.

5. The terminal image quality enhancement method according to claim 2, wherein a training process of the image super-resolution model comprises:
using y series-connected image super-resolution models with a same structure and a same internal parameter for training, wherein 1<y≤I1 and I1 is a maximum number of cycles that a terminal supports to use the image super-resolution model cyclically, and calculating a loss of using 1 to y image super-resolution models at the same time, wherein floating-point precision is adopted during training; and
quantifying a trained floating-point image super-resolution model into an integer image super-resolution model.

6. The terminal image quality enhancement method according to claim 1, wherein the image quality enhancement model is a clarity enhancement model, and the image quality enhancement parameter is a second image quality enhancement parameter w, wherein 0<w≤100%;
the determining the number of cycles J of image quality enhancement using the image quality enhancement model according to the image quality enhancement parameter of the user comprises:
determining a maximum number of cycles I that a terminal supports to cyclically use the clarity enhancement model, and dividing 0 to 100% into I equal parts, a percentage of enhancement corresponding to an i-th equal part is A*100%, wherein (i−1)/I<A≤i/I, and i is a natural number between 1 and I; and
determining that a number of equal parts corresponding to the second image quality enhancement parameter w is the number of cycles J of image quality enhancement using the clarity enhancement model.

7. The terminal image quality enhancement method according to claim 6, wherein the determining the maximum number of cycles I, comprises:
detecting computing power space M that a current terminal is capable of providing to an image quality enhancement algorithm;
determining whether M is greater than or equal to I2*M_{bp}, wherein I2 is a maximum number of cycles that the terminal supports cyclically using the clarity enhancement model in an ideal situation, M_{bp} is computing power space required for performing image quality enhancement on the image to be enhanced once by using the clarity enhancement model;
when M is greater than or equal to I2*M_{bp}, setting the maximun number of cycles I=I2; and
when M is less than I2*M_{bp}, setting the maximun number of cycles I=└M/M_{bp}┘, wherein └M/M_{bp}┘ means rounding down a value of M/M_{bp}.

8. The terminal image quality enhancement method according to claim 6, wherein when w is not equal to an integer multiple of 1/I, the method further comprises:
calculating a difference coefficient according to a following formula w′, w′=w*I−J+1;
determining that an output image is BP^{J-1}(P)+w′*(BP^{J}(P)−BP^{J-1}(P)) wherein BP^{J-1}(P) is an output image of the clarity enhancement model in a (J−1)-th cycle, BP^{J}(P) is an output image of the clarity enhancement model in a J-th cycle.

9. The terminal image quality enhancement method according to claim 6, wherein the clarity enhancement model comprises a first residual block, the first residual block comprises a first main branch, a first shortcut branch, and a first adder, the first main branch and the first shortcut branch are both disposed between an input image and the first adder, and the first residual block is configured to sum the input image and the input image after being processed by the main branch and perform outputting; the first main branch comprises a downsampling layer, a second residual block, a fifth clip layer, and a second upsampling layer connected in sequence, wherein:
the downsampling layer is configured to downsample the input image to obtain a downsampled image;
the second residual block comprises a second main branch, a second shortcut branch, and a second adder, both the second main branch and the second shortcut branch are disposed between the downsampling layer and the second adder, the second main branch comprises a plurality of second convolution layers and a sixth clip layer disposed between the plurality of second convolution layers;
the fifth clip layer is configured to limit a numerical value of a feature map output by the second residual block within a preset range; and
the second upsampling layer is configured to convert a feature map output by the fifth clip layer into a high-resolution image.

10. The terminal image quality enhancement method according to claim 6, wherein a training process of the clarity enhancement model comprises:
using z series-connected clarity enhancement models with a same structure and a same internal parameter for training, wherein 1<z≤I, and calculating a loss of using 1 to z clarity enhancement models at the same time, wherein floating-point precision is adopted for training; and
quantifying a trained clarity enhancement model into an integer clarity enhancement model.

11. The terminal image quality enhancement method according to claim 1, wherein the image quality enhancement model comprises an image super-resolution model and a clarity enhancement model, and the image quality enhancement parameter comprises a first image quality enhancement parameter s and a second image quality enhancement parameter w;
the determining the number of cycles J of image quality enhancement using the image quality enhancement model according to the image quality enhancement parameter of the user, comprises: determining a number of cycles J1=s of image quality enhancement using the image super-resolution model; determining a maximum number of cycles I of image quality enhancement using the clarity enhancement model, and dividing 0 to 100% into I equal parts, and a percentage of enhancement corresponding to an i-th equal part is A*100%, wherein (i−1)/I<A≤i/I, and i is a natural number between 1 and I; and determining that a number of equal parts corresponding to the second image quality enhancement parameter w is a number of cycles J2 of image quality enhancement using the clarity enhancement model; and
the cyclically using the image quality enhancement model to enhance the image quality of the image to be enhanced for J times, comprises: first cyclically using the clarity enhancement model to enhance the image quality of the image to be enhanced for J2 times, and outputting a first image quality enhanced picture; cyclically using the image super-resolution model to enhance image quality of the first image quality enhanced picture for J1 times, and outputting a second image quality enhanced picture.

12. A terminal image quality enhancement apparatus, comprising a memory and a processor connected to the memory, wherein the memory is configured to store instructions, the processor is configured to perform steps of a terminal image quality enhancement method according to claim 1 based on the instructions stored in the memory.

13. A computer readable storage medium on which a computer program is stored, wherein when the program is executed by a processor, a terminal image quality enhancement method according to claim 1 is implemented.
